(19) United States
(12) Patent Application Publication
(10) Pub. No.: US 2002/0000731 A1
(43) Pub. Date: Jan. 3, 2002

(54) Offroad search and rescue vehicle

(76) Inventors: Ardell G. Wieczorek, Merlin, OR (US); Mark D. Wieczorek, San Diego, CA (US)

Correspondence Address: Mark D. Wieczorek, PO Box 70072, San Diego, CA, 92167, US

(21) Appl. No.: 09/897,849

(22) Filed: Jul. 2, 2001

Related U.S. Application Data
(63) Continuation-in-part of application No. 09/373,886, filed on Aug. 12, 1999, now Pat. No. 6,254,159.

(51) Int. Cl. B60P 3/00

(52) U.S. Cl. 296/24.1

(57) ABSTRACT

The invention is directed to an apparatus to attract a missing person in a search and rescue operation. The apparatus includes a vehicle having a body; a plurality of equipment for use in response to a search and rescue emergency disposed within and on the vehicle, the plurality including a siren and a beacon; a power source for powering at least the siren and the beacon; and a circuit coupled to the siren and the beacon for controlling the siren and the beacon.

### CROSS-REFERENCES TO RELATED APPLICATIONS

This is a continuation-in-part of U.S. patent application Ser. No. 09/373,886 to Wieczorek et al., entitled “Offroad Search and Rescue Vehicle”, filed Aug. 12, 1999, now U.S. Pat. No. 6,254,159.

### BACKGROUND OF THE INVENTION

A. Field of the Invention

This invention pertains to emergency response vehicles and, more particularly, to vehicles especially equipped with various modules to provide multiple essential emergency services in remote locations.

B. Description of the Related Art

U.S. Pat. No. 5,573,300 to Simmons describes a utility vehicle employing interchangeable emergency response modules. The disclosed vehicle is apparently useful for reaching otherwise inaccessible areas in an industrial plant, and also has interchangeable modular response units which can be removed from the vehicle for separate use or alternatively for installation on a separate utility vehicle.

A vehicle according to the Simmons '300 patent may be very useful in its intended use in an industrial plant. However, the same would be considerably less useful in the field of search and rescue. There is a need for a rescue cart which can be disposed in a mountain or desert location for purposes of attracting a lost or missing person. For example, there is a need for a rescue cart with appropriate signalling capabilities, such as aural and optical, to attract a lost or missing person.

### SUMMARY OF THE INVENTION

In one aspect, the invention is directed to an apparatus to attract a missing person in a search and rescue operation. The apparatus includes a vehicle having a body; a plurality of equipment for use in response to a search and rescue emergency disposed within and on the vehicle, the plurality including a siren and a beacon; a power source for powering at least the siren and the beacon; and a circuit coupled to the siren and the beacon for controlling the siren and the beacon.

Implementations of the invention may include one or more of the following. The plurality of equipment may further include a microphone coupled to a signal processor. At least one of the siren, the beacon, or the microphone may be mounted on a rotating turret. A console may be provided to control the siren and the beacon.

The plurality of equipment may further include equipment for rescue of persons and tactical operations by law enforcement personnel. The equipment for rescue of persons and tactical operations by law enforcement personnel may include: a) means for rescuing persons and tactical operations; b) an emergency warning light; c) an area light; d) a siren; e) a control panel; and g) a storage compartment.

The means for rescuing persons and tactical operations may include: a) a hydraulic rescue tool; b) a confined space rescue tripod; c) an axe; d) a fire extinguisher; e) a generator; f) a portable work light; g) a rope; h) a self-contained breathing apparatus; I) a plurality of poles to prod into snow, ice, etc., for location of buried persons; j) a longhandled hook for water rescues; k) flares; l) signalling mirrors, m) a CB radio; and n) a winch employing a chain or rope which may be used to haul up a lost person or lower a rescuer.

The plurality of equipment may also include equipment for provision of emergency medical treatment, such as: means for treating sick and injured persons; and a storage compartment.

The means for treating sick and injured persons may include: a) a cardiac defibrillator; b) an aneroid sphygmomanometer; c) an intravenous fluid delivery means; d) an oxygen cylinder and bracket therefor; e) a patient cot and fastener therefor; f) a back board; and g) a plurality of medical supplies.

This invention provides several advantages over previous emergency response vehicles. For example, the invention provides a vehicle that can maneuver on difficult terrain. The invention provides a vehicle equipped with numerous devices structured, configured, and designed to attract a missing person in a wilderness, forest, tundra, woods, mountain, valley, desert, or other locale which tends to attract hikers, walkers, hunters, skiers, or other sportspersons.

These and other objects and advantages of the present invention will become more apparent from the description hereinafter.

### DESCRIPTION OF THE DRAWING

In the drawing, which illustrates an embodiment of the present invention and is not intended to be limiting:

FIG. 1 is a side cross-sectional view of a first embodiment of a search and rescue utility vehicle, constructed in accordance with the principles of the invention.

FIG. 2 is a top schematic view of a second embodiment of a search and rescue utility vehicle constructed in accordance with the principles of the invention.

FIG. 3 is a side schematic view of a third embodiment of a search and rescue utility vehicle constructed in accordance with the principles of the invention.

FIG. 4 is a perspective cutaway view of a fourth embodiment of a search and rescue utility vehicle constructed in accordance with the principles of the invention.

FIG. 5 is a side schematic view of a fifth embodiment of a search and rescue utility vehicle constructed in accordance with the principles of the invention, this embodiment having certain features in common with the third embodiment.

FIG. 6 is a side schematic view of a sixth embodiment of a search and rescue utility vehicle constructed in accordance with the principles of the invention, this embodiment having certain features in common with the first embodiment.

### DESCRIPTION OF THE PREFERRED EMBODIMENTS

Although hereinbelow are described what are at present considered the preferred embodiments of the invention, it will be understood that the invention can be embodied in other specific forms without departing from the spirit or essential characteristics thereof. The present embodiments are, therefore, to be considered in all aspects as illustrative and not restrictive. Accordingly, the invention is limited solely by the claims appended hereto.

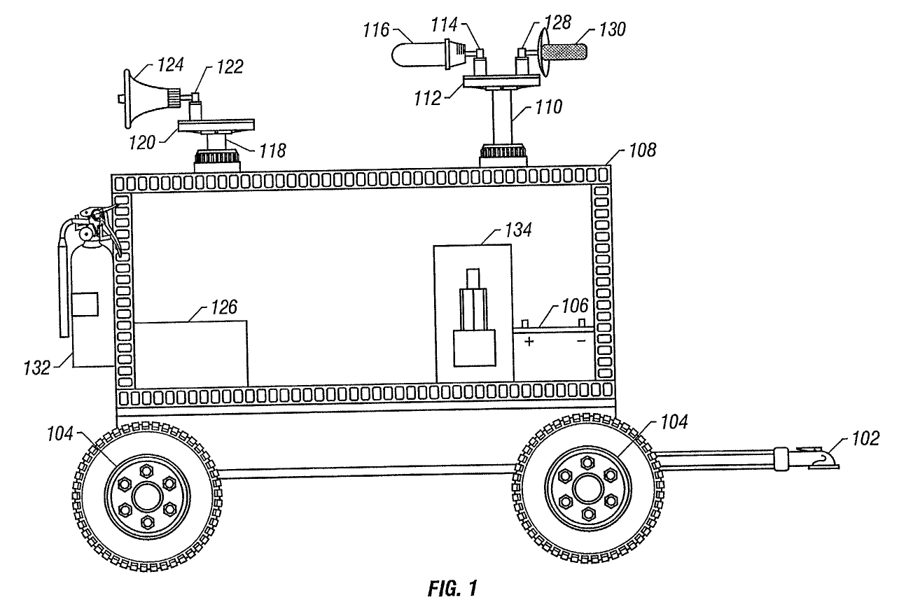

Turning now to the drawing, in which similar reference characters denote similar elements throughout several views, FIG. 1 illustrates one embodiment of a search and rescue vehicle constituting this invention.

The embodiment shown in FIG. 1 consists of a utility vehicle in the form of a trailer 108. In this embodiment, the utility vehicle 108 is shown as a trailer. However, it is an object and an advantage of the present invention that the vehicles disclosed herein are adaptable to many different vehicles, including, but not limited to, four-wheel drive vehicles, snowmobiles, amphibious vehicles, sport utility vehicles, etc. For purposes of this Patent Specification, utility vehicle shall be defined to include snowmobiles, snow-cats, amphibious vehicles, and other vehicles designed for operation on surfaces other than pavement. In this first embodiment, the trailer is shown having a basically closed form, i.e., a box-type enclosure covers much of the contents of the utility vehicle.

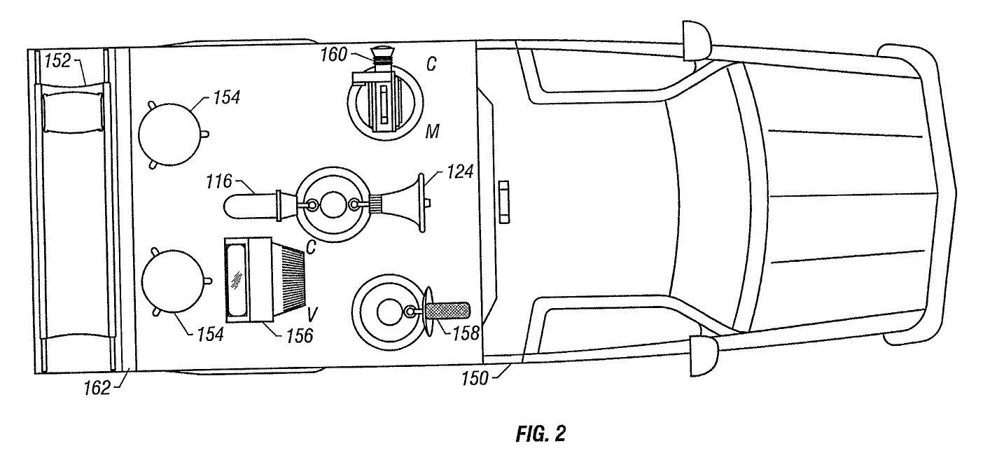

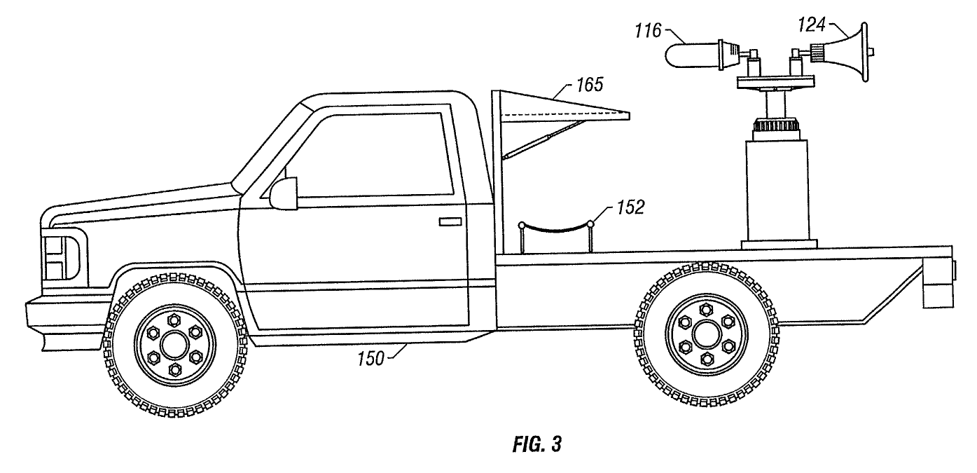

The trailer 108 may be towed by a powered vehicle (see also FIGS. 2-3) or may be a powered vehicle itself. In the embodiment of FIG. 1, in which the trailer 108 is towed, a tow bar and attachment socket 102 may conveniently be employed. The trailer 108 may have at least two wheels 104, and preferably four to allow sufficient stability when the trailer 108 is unhitched from the towing vehicle. The use of four wheels may also allow more alternator-supplied power to recharge the batteries of the search and rescue devices employed by the vehicle. In other words, each wheel may power a generator or alternator, an example of which is shown by alternator 134, which may in turn power the sirens and lights to be described below. More particularly, the alternator 134 may supply power to rechargeable battery cells 106 which in turn power the search and rescue devices. The floor of the trailer may have a hollow horizontal section in which to store the battery cells 106. As the battery cells 106 may be quite heavy, the same may be situated in the four, or however many, corners of the trailer to evenly weight the trailer. In the case of the embodied trailer, the weighting should allow a regular-size truck or SUV to pull the vehicle. In the case of the rescue vehicle having its own engine, appropriate weighting may include a consideration of the weight of the engine.

In some circumstances, the trailer may be embodied in a cart that may be disposed in the bed of a full-size pickup truck. In this case, the size may be, for example, 6′ by 8′. If desired for manufacturing reasons, the cart may be the same size in all embodiments but may be placed on a trailer in a way similar to that described above to be towed or may alternatively be placed in the bed of a pickup truck.

In the upper section of the trailer, above the batteries, e.g., other supplies may be held, including extra water, medicines, food rations, warming blankets, and extra spotlights. Room may be allowed for carriage of the person once they are located: a board, sliding on rails, could be employed to push the rescued person onto the floor of the top section. Numerous doors could be provided, on both the bottom and the top layers, to allow entry by rescue personnel to retrieve any of the items mentioned, as well as similar other items.

The trailer 108 may further include a fire extinguisher 132 to be used in case the search and rescue mission occurs in a fire zone.

The particularly important portions of the trailer are shown mounted to its roof. It will be clear to one skilled in the art that the same may be mounted on the side or in various other configurations, such as within a cage in the interior of the trailer, so long as the trailer had open sides.

The trailer may employ devices that assist in search and rescue procedures. In particular, these devices may serve to attract a lost or missing person to the vicinity of the trailer. These devices may include, or in subcombinations thereof, a siren or speaker 124, a search light or rescue beacon 116, and a highly sensitive microphone 130. Each may be mounted rotatably, such as on a rotating turret, to increase the range of effect of the signaling device.

For example, the siren 124 may be mounted via mount 122 to mount 120 on rotating turret 118. Similarly, the light or beacon 116 may be mounted via mount 114 to mount 112 on rotating turret 110. And correspondingly, the microphone 130 may be mounted via mount 128 to mount 112 on rotating turret 110. It is advantageous to have the light or beacon 116 mounted at an altitude higher than the remaining devices so that the light is not blocked from reaching potential vicinities where missing persons may be notified of its presence.

The siren 124 may employ both a loud police-car-type siren, known for its far-reaching coverage, and a separate aural indication of the nature of the source, e.g., the siren may announce the presence of a rescue vehicle. In this case, a recorded message, such as from a relative of the victim or lost person, may be employed to further attract the lost person. It is known that some rescued persons, particularly in confused or desperate states, may feel threatened by rescuers.

Such persons may be attracted, and comforted, by hearing a familiar voice, or at least by hearing that the rescuers are genuinely rescuers and not, e.g., hunters.

In times when the siren (or “bullhorn”) is not operating, the microphone 130 may listen to noises in the missing person's vicinity to determine if the noises are likely to correspond to a lost person. To this end, special filtering and signal processing may be performed on the microphone output to filter out known noises due to wind, brustling trees, leaves, birds, etc. The angular dependence of the noise may give a further indication of at least the angle at which the missing person is located, if not also the distance.

Another electrical connection to the vehicle 108 may be a power cord. The same may be used in situations where an electrical outlet is available. Of course, the vehicle may also operate using power from generators, etc.

FIG. 2 shows an alternate embodiment of the invention that is embodied in the form of a device that may be carried in the bed of a full-size pickup truck 150. In this case, the device may be of dimensions about 6′ by 8′. The truck 150 may have a bed that can hold a stretcher 152 in which a person may be situated. The stretcher 152, which may also be in the form of a gurney, may employ rails that mate with corresponding rails on the truck to provide a secure connection and to eliminate movement during vehicle operation. To conserve space, the rails for the gurney may be mounted above short cabinetry to allow necessary items to be stored below the rails and gurney. Two chairs or stools 154 may be disposed next to the stretcher for assisting the lost person in the stretcher 152. The chairs 154 may employ seat belts (not shown) for safety. It is envisioned that with a full-size truck bed, the stretcher will account for space such that at least a 5′ by 6′ area is left available for the siren, lights, storage boxes, etc.

A video monitor 156 may be disposed adjacent one of the chairs 154 to enable a rescuer to monitor the various instruments on the device. For example, a siren or horn or speaker 124 may be located at a high location on the truck bed as described in connection with FIG. 1 above. In the same way, a high-intensity light, such as a halogen lamp 116, may also be so located. Instruments such as a listening device 158 and an optical detector 160 may be located at the extremities of the truck bed in order to listen and watch for lost persons employing an acuity that unassisted human senses are not capable of. For example, the listening device 158 may be especially tuned to human voice frequencies and may have high-power amplifiers connected thereto. Optical detector 160 may have high-power optics such as telescopic lenses employing color filters to render the rescuers more likely to be able to sense a lost person given the environment; e.g., a filter may absorb green light for a search performed in a forest.

In this second embodiment, the space in which the instruments and patient are located may be either open or closed. In other words, a box-type enclosure similar to that of FIG. 1 may be employed, or alternatively an open structure more similar to that of FIG. 3 may be employed. Alternatively, a combination structure may be employed in which a retractable cover extends over the bed of the truck, enclosing or opening the space as required by the dictates of the user.

FIG. 3 shows a third embodiment of the invention. This embodiment is similar to the embodiment of FIG. 2 in several respects. However, FIG. 3 also shows a retractable cover 165 over the patient gurney or stretcher 152. The retractable cover 165 may be employed to cover the patient on his or her trip to a city or hospital as needed. The retractable cover 165 may be especially employed in harsh environments, such as rain, snow, etc.

The vehicle may also include a base station for reception of signals from locating devices such as from EPIRBs or walkie-talkies having embedded therein locating devices. It is envisioned that hikers, for example, may purchase or rent such locating devices from ranger stations, sporting goods stores, etc. These devices may be specific to the forest or vicinity in which the hiker may be hiking. If the hiker is lost, the hiker may activate the signal sending portion of the locating device to cause a signal to be sent out. The locating device may have, for example, a working radius for sending signals of several tens of miles. The base station may be preset to the frequency of transmission (if the same is known) or may alternatively scan numerous frequencies (if the frequency of transmission is unknown). It should also be noted that the same could be activated upon contact with water, darkness, or other such environmental condition so as to alert a rescue team in the case where the hiker is disabled or unconscious.

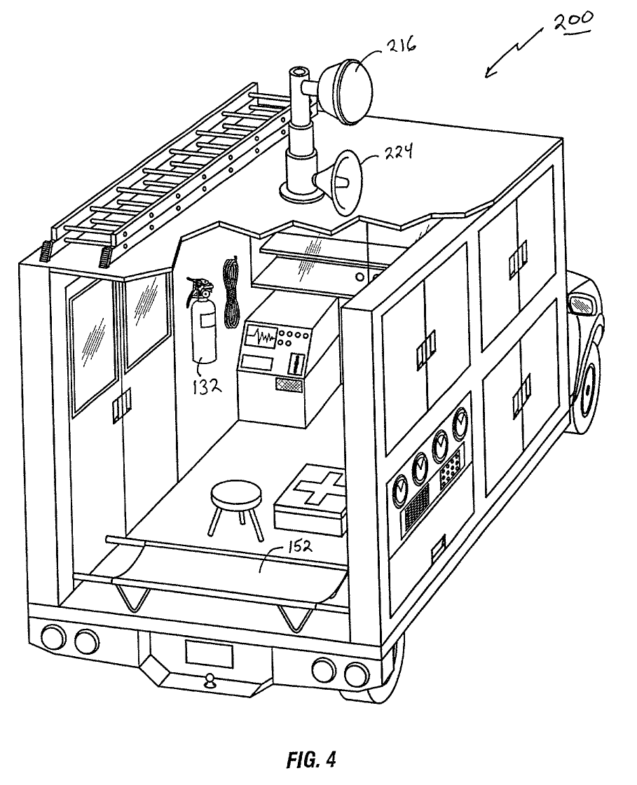

FIG. 4 shows a fourth embodiment of the invention. In this embodiment, “carry-an” type vehicle 200 is employed to carry the instruments and equipment necessary to perform a search and rescue, including a search light 216 and a horn 224. Such a vehicle may be constructed with this purpose in mind, and its size, which is variable, may accommodate the type of search and rescue expected for a given area. For example, in a heavily forested area, the vehicle may be made small so that the same may be navigable around trees, etc. In a more arid environment, of course, the vehicle may be made as large as necessary. In any case, the vehicle is preferably made with a 4-wheel drive capability so that rigorous terrain of any type may be traveled over.

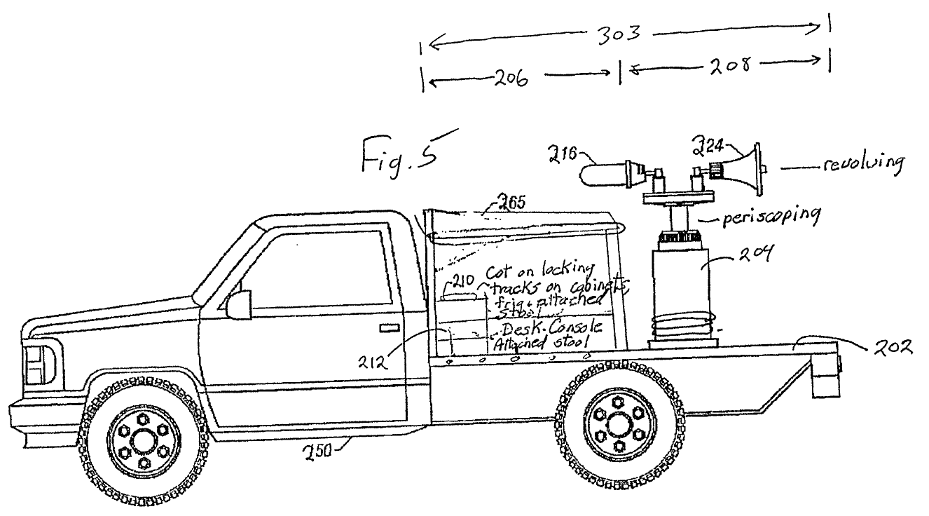

Referring to FIG. 5, a fifth embodiment of the invention is shown, this embodiment having certain features in common with the third embodiment. FIG. 5 shows a vehicle 250, which may be a pick-up or other such truck, e.g., including a flat-bed truck. On a flat bed 202 may be disposed a pedestal 204 on which may be mounted a search light 216 and a horn 224. As noted above, horn 224 may include a listening device, or the listening device may be separate. The pedestal 204 may employ a periscoping capability in that the same may be raised or lowered according to the dictates of the user, as well as the environment or terrain being searched. In the same way, the pedestal may allow for the rotation of the light and/or horn. The pedestal 204 may be weighted appropriately so that a pulley may be mounted to its base. For example, the pedestal may be located at approximately the center of gravity of the truck 250.

As can be seen, the bed may be thought of as separated into two sections: roofed section 206 and open section 208. The two sections taken together, or generally the area 303 aft of the driving compartment or cab, is referred to here as the “rescue area” 303. Such a split allows the equipment occupying more space, such as the pedestal, to be located on the same bed as the equipment occupying less space, such as a cot 210. To allow an even more efficient use of space, cot 210 may be mounted on locking tracks or rails above one or a plurality of cabinets 212. Such cabinets may be used for first aid supplies, a refrigerator, etc. Adjacent or near cot 210 may be located and attached a stool, desk, and/or console for use by the rescuer or caregiver. Other such furniture, including one or a plurality of benches, may be employed on the sides of the bed 202 not only for repose but also to act as a barrier against a rescuer or caregiver falling off of the bed 202.

Of course, one of skill in the art will recognize that other features, such as a roll-up canvas with a hole cut therein for disposition of the pedestal 204, could be used to cover the open section 208 on a temporary basis. Further, features from the other embodiments, such as the cabinets through which the gurney may pass in FIG. 4, may be employed in this or other embodiments.

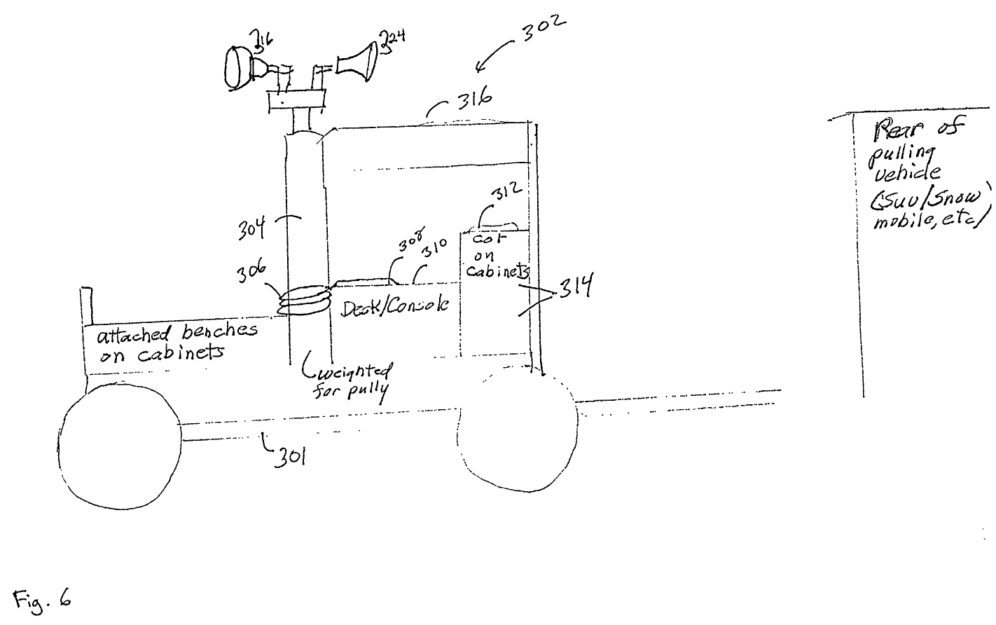

Referring to FIG. 6, a sixth embodiment of the invention is shown, this embodiment having certain features in common with the first embodiment. In particular, a trailer-based rescue vehicle 302 is shown with a search light 316 and a horn 324 mounted thereon. The light and horn are preferably mounted on a pedestal 304. Pedestal 304 is preferably weighted so that a pulley, winch, or other such rescue device 306 may be mounted thereon. Pedestal 304 is also such that the same is securely mounted on the trailer base 301. Trailer base 301 may be similar to other trailers, in that the same may have a standard configuration so as to be capable of being pulled behind a vehicle using the standard ball/hitch type devices.

The pedestal 304 may be approximately aft of the covered section 316. Within covered section 316 may be a desk 310, a console 308, a cot 312, and cabinets 314. These features may be similar to the same-named features described above. Aft of the covered section 316 may be a roll-up canvas or other type of covering.

The sides and front of the covered area may be enclosed with walls in which small cabinets are disposed. One set of “cabinet” doors may lead to a cot for the victim, or alternatively to the tracks whereby a gurney may be engaged. Within the rear uncovered section may be provided, e.g., other cabinets, a ladder, various rescue equipment, attached benches on cabinets, etc.

The advantages of this type of covered/uncovered vehicle are manyfold. For example, a rescuer may stand erect on the vehicle bed, whether it be of a carry-van, pick-up, flat-bed, and/or trailer design, and visually search the environs for the victim. The rescuer may more easily attend to the repair of the horn, e.g., siren, and search light in this design. Other advantages will be apparent to one of ordinary skill in the art.

The manner of usage and operation of the invention described above being readily apparent from the above disclosure, no further discussion relative to the manner of usage and operation of the invention shall be provided.

With respect to the above description, it is to be understood that the optimum dimensional relationships for the parts of the invention, as well as variations in size, materials, shape, form, function, and manner of operation, assembly, and use, and equivalents of all the foregoing, are apparent to one skilled in the art. Such equivalents are intended to be encompassed by the present invention.

Therefore, the foregoing is considered as illustrative only of the principles of the invention. Further, since numerous modifications and changes will be readily apparent to those skilled in the art, it is not intended to limit the invention to the exact construction and operation shown and described, but to encompass all suitable modifications and equivalents within the scope of the invention.

The scope of the invention is indicated by the appended claims rather than by the foregoing description.

What is claimed is:

1. An apparatus for use in a search and rescue, comprising:
a) a vehicle having a body and a rescue area;
b) a plurality of equipment for use in response to a search and rescue emergency disposed within and on said vehicle, said plurality including a horn and a search light;
c) a power source for powering at least said siren and said beacon;
d) a circuit coupled to said siren and said beacon for controlling said siren and said beacon; and
e) a cover for covering at least a portion of the rescue area.

2. The apparatus of claim 1, wherein at least one of said siren, said beacon, and said microphone are mounted on a rotating turret.

3. The apparatus of claim 1, further comprising a console controlling said siren and said beacon.

4. The apparatus of claim 1, wherein said plurality of equipment includes equipment for rescue of persons and tactical operations by rescue personnel.

5. The apparatus of claim 4, wherein said equipment for rescue of persons and tactical operations by rescue personnel includes:
a) means for rescuing persons and tactical operations;
b) an emergency warning light;
c) an area light;
d) a siren;
e) a control panel; and
f) a storage compartment.

6. The apparatus of claim 1, wherein said plurality of equipment includes equipment for provision of emergency medical treatment.

7. The apparatus of claim 5, wherein said means for rescuing persons and tactical operations comprises:
a) a hydraulic rescue tool;
b) a confined space rescue tripod;
c) an axe;
d) a fire extinguisher;
e) a generator;
f) a portable work light;
g) a rope; and
h) a self-contained breathing apparatus,

7. The apparatus of claim 6, wherein said equipment for provision of emergency medical treatment includes:
a) means for treating sick and injured persons; and
c) a storage compartment.

9. The apparatus of claim 7, wherein said means for treating sick and injured persons comprises:
a) a cardiac defibrillator;
b) an aneroid sphygmomanometer;
c) an intravenous fluid delivery means;
d) an oxygen cylinder and bracket therefor;
e) a patient cot and fastener therefor;
f) a back board; and
g) a plurality of medical supplies.
